(19) United States
(12) Patent Application Publication
(10) Pub. No.: US 2025/0005009 A1
(43) Pub. Date: Jan. 2, 2025

(54) DATABASE MANAGEMENT SYSTEM

(71) Applicant: BRITISH TELECOMMUNICATIONS PUBLIC LIMITED COMPANY, London, Greater London (GB)

(72) Inventor: Robert HERCOCK, London, Greater London (GB)

(21) Appl. No.: 18/712,160

(22) PCT Filed: Oct. 5, 2022
(86) PCT No.: PCT/EP2022/077736

§ 371 Date: May 21, 2024

(30) Foreign Application Priority Data
Nov. 25, 2021 (GB) 2116983.4

(51) Int. Cl. G06F 16/22; G06F 16/28

(52) U.S. Cl. CPC G06F 16/2264; G06F 16/2237; G06F 16/285

(57) ABSTRACT

In various examples there is a database management system which has a memory storing a plurality of addresses of items. The database management system has a mapping component for computing a mapped location of each item in a plane or volume comprising a plurality of tessellated cells. The memory stores, for individual ones of the items, the mapped location of the item.

### BACKGROUND

Relational databases are widely used and store data in collections of tables with each table having rows and columns. Relational operators are used to manipulate the data in the tables and unique keys are used to identify each row. Query languages such as structured query language SQL are used to manage relational databases. Graph databases are also known where data items are stored using a collection of nodes connected by edges, where the edges represent relationships between the nodes.

In a particular database deployment, the type of database technology used, be it relational, graph or other is typically chosen based on the circumstances and characteristics of the deployment.

The embodiments described below are not limited to implementations which solve any or all of the disadvantages of known database technologies.

### SUMMARY

The following presents a simplified summary of the disclosure in order to provide a basic understanding to the reader. This summary is not intended to identify key features or essential features of the claimed subject matter nor is it intended to be used to limit the scope of the claimed subject matter. Its sole purpose is to present a selection of concepts disclosed herein in a simplified form as a prelude to the more detailed description that is presented later.

In various examples there is a database management system comprising: a memory storing a plurality of addresses of items and a mapping component for computing a mapped location of each item in a plane or volume comprising a plurality of tessellated cells. The memory stores, for individual ones of the items, the mapped location of the item. Thus, a new type of database technology is provided which differs from relational database technology and from graph-based database technology. The plane or volume, with the tessellated cells, acts as a type of co-ordinate system to enable navigation of the database. The mapped locations are locations in the plane or volume and in this way an item has a location in the plane or volume comprising the plurality of tessellated cells. Using the locations in the plane or volume various database management methods are facilitated such as querying of the database, distributing the database, and inference and prediction of items to be added to the database.

Preferably the location in the plane or volume is one or more of: a Cartesian coordinate, an identifier of one of the tessellated cells. By using Cartesian coordinates as the locations, there is a simple and intuitive way to express the locations and to navigate items in the database. Since the locations are Cartesian coordinates it is possible to efficiently compute distances between locations of two items in the database, to express geometric shapes or curves separating items in the database, to apply transformations such as translations, rotations, reflections, affine transformations and others to items in the database. Where the location is expressed as an identifier of one of the tessellated cells, there is an efficient way to compute distances between items in the database and/or retrieve items from the database using cell identifiers.

Preferably the mapping component is configured to build a multi-dimensional vector space encoding semantic distance between the items and to compute, for an individual one of the items, a vector embedding of the item in the multi-dimensional space, and to apply a dimension reduction process to the vector embedding to output a location in the plane or volume. This gives an efficient way to add locations of items in the database. This method is found extremely effective in practice such as for managing items of cyber security event data in a database management system or for other types of data. By using a multi-dimensional vector space to encode the items, items which are semantically similar are closer together in the multi-dimensional space. When the multi-dimensional space is then reduced to produce a plane or 3D volume some of the information about semantic similarity from the multi-dimensional space is preserved. Thus, the locations of the items in the plane or volume also capture semantic similarity of the items as closeness in the plane or volume to some degree.

In various examples the mapping component is configured to: build a multi-dimensional vector space encoding semantic distance between the items; compute the plane or volume by computing a dimension reduced version of the vector space; construct the tessellated cells over the dimension reduced version of the vector space. This gives an effective way to compute the plane or volume and construct the tessellated cells to be suitable for creating a map of the items in the database.

Preferably the mapping component described above is configured to assign cluster labels to regions of the dimension reduced version of the vector space. The cluster labels facilitate human understanding of the locations in the database so that it is possible to give an explanation to a user as to why particular items have been retrieved from the database in some cases.

In various examples the dimension reduction process comprises a bias function to maximize a fit of the dimension reduced version of the vector space to a plane or volume comprising the tessellated cells. Using a bias function is found to facilitate fit of the item locations within the plane or volume.

In examples there is a processor configured to receive a query comprising an example item; use the mapping component to map the query to a location in the plane or volume, and to return items from the memory which are within a specified distance of the query location. In this way an efficient query by example facility is provided. It is possible to efficiently compute distances between the query example location and locations of other items in the database by computing Euclidean distances.

Preferably, the plurality of tessellated cells comprises a plurality of layers of tessellated cells. By using a plurality of layers the capacity of the database is increased. Also, the structure of the knowledge in the database can be enhanced so as to facilitate various database operations. The layers lend themselves to parallelization and distribution since individual ones of the layers can be processed in parallel and since individual ones of the layers can be stored in separate locations.

In an example, each layer of tessellated cells encodes a different type of characteristic of the items. Where an item has a plurality of characteristic types it has a plurality of locations (one per characteristic type layer) and these plurality of locations are concatenated in some examples. In an example, a first layer of tessellated cells encodes cyber security threat intelligence data and a second layer of tessellated cells encodes advanced persistent threat data.

Preferably, the mapping component is configured to map at least one of the items to a first location in a first layer of the tessellated cells and also to a second location in a second layer of the tessellated cells. In the example mentioned above, a first layer of tessellated cells encodes cyber security threat intelligence data and a second layer of tessellated cells encodes advanced persistent threat data. A new data item that comprises both cyber security threat intelligence data and advanced persistent threat data is mapped to a location in the first layer and to a second location in the second layer. In this way the new data item is accurately stored in terms of locations in the database.

In one or more examples, the plurality of tessellated cells comprises a first group representing a first knowledge domain and a second group representing a second knowledge domain different from the first knowledge domain, and wherein the first group joins the second group. The first group may be in one generally contiguous region of the layer or volume and the second group in another, different generally contiguous region of the layer of volume. Since the regions are joined retrieval of related items from the database if facilitated where these items are otherwise in different knowledge domains.

Preferably, at least one of the cells has been divided using sub-cell scaling whereby a recursive cell division process is applied to the cell and to new cells divided from the cell. By using cell division different regions of the plane or volume have varying density of cells so that the granularity of storage is controllable by controlling the amount of cell division. Using cell division in this way facilitates efficient use of storage capacity in the database since increased density of cells is only used where needed.

In various examples the database management system comprises a prediction component, which predicts items by adding cells to edges of the tessellated cells or to gaps between the tessellated cells. In this way it is possible to dynamically grow the database.

Preferably the memory stores instructions which when executed on a processor act to:
receive a query comprising a cell identifier of one of the tessellated cells, and retrieve from memory, locations of other items which have locations in the same cell or a neighboring cell; OR
receive a query comprising a location and retrieve from memory, locations of other items which are within a threshold distance of the received location.

These methods of querying the database are efficient since the process of searching for a cell identifier in a list or range of possible cell identifiers is computationally scalable for large numbers of cells in an efficient manner. Searching for locations of other items which are within a threshold distance of the received location is also efficient and scalable.

In various examples there is a computer-implemented method comprising:
storing, at a memory, a plurality of addresses of items;
mapping each item to a location in a plane or volume comprising a plurality of tessellated cells;
for individual ones of the items, storing the location of the item in the plane or volume.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 is a schematic diagram of a database management system;

FIG. 2 is a schematic diagram of examples of cells tessellated in a volume for use with the database management system of FIG. 1;

FIG. 3 shows two layers of cells for use with the database management system of FIG. 1;

FIG. 4 is a flow diagram of a method of constructing a grid of cells for use with the database management system of FIG. 1;

FIG. 5A is an example of a plane comprising tessellated cells and items mapped to the plane;

FIG. 5B is a flow diagram of a method of mapping new items to a plane or volume for use with the database management system of FIG. 1;

FIG. 6 is flow diagram of a method of processing a query at the database management system of FIG. 1.

Like reference numerals are used to designate like parts in the accompanying drawings.

### DETAILED DESCRIPTION

The detailed description provided below in connection with the appended drawings is intended as a description of the present examples and is not intended to represent the only forms in which the present examples are constructed or utilized. The description sets forth the functions of the examples and the sequence of operations for constructing and operating the examples. However, the same or equivalent functions and sequences may be accomplished by different examples

The present disclosure relates to a new type of database technology inspired by the existence of grid cells in the entorhinal cortex. Grid cells enable animals to navigate by providing an internal coordinate and mapping system. Animal grid cells exist in a hexagonal grid pattern within the entorhinal cortex, next to the hippocampus region of the brain, (which contains place cells). There can also be multiple overlapping layers of grid cells in the entorhinal cortex which allows triangulation between grids. The hexagonal grid is a function of cells firing at the vertices of equilateral triangles. This creates a natural six-fold symmetry in the grid cell operation. It has also been demonstrated that in humans grid cells enable the navigation of abstract information spaces.

Embodiments herein are concerned with how to create a new type of database management system which enables navigation of items stored in a database using tessellated topologies. In various examples described later, a tessellated topology comprises a plane or volume having a plurality of tessellated cells. How to automatically construct such a plane or volume for a particular corpus of items to be stored in a database is not straightforward. Within the plane or volume individual items have locations where the relative spatial locations of the items in the plane or volume represents semantic relationships between the items to some extent.

Vector Embedding methods are approaches used to create a high dimensional vector space, in which concepts and data are relatable. However, it is recognized herein that vector embedding methods suffer from several key issues. First the computational requirements to build a vector model from a large corpus of data are significant. Second, the inference process to lookup the relationships between a new fact and the existing vector model are also costly, as the vector length is substantial, varying from 50-300 float values in length. Third, the output vector model is not generalizable, or easy to integrate with separate models.

The process of semantic classification and analysis was a major theme in computer science and machine learning. Unfortunately, it also proved to be an impossible task. The efforts to hand code all knowledge into a machine-readable form, proved to be a major challenge. Many formats were designed to structure information, such as rdf triples.

With the advent of deep learning, it became possible to construct a vector representation of the semantic relationships between knowledge points/facts. This has proved to be extremely useful in all forms of natural language processing (NLP), and a range of other classification tasks in machine learning.

However, the embedding methods require significant computational resources to deliver the vector state for each input item.

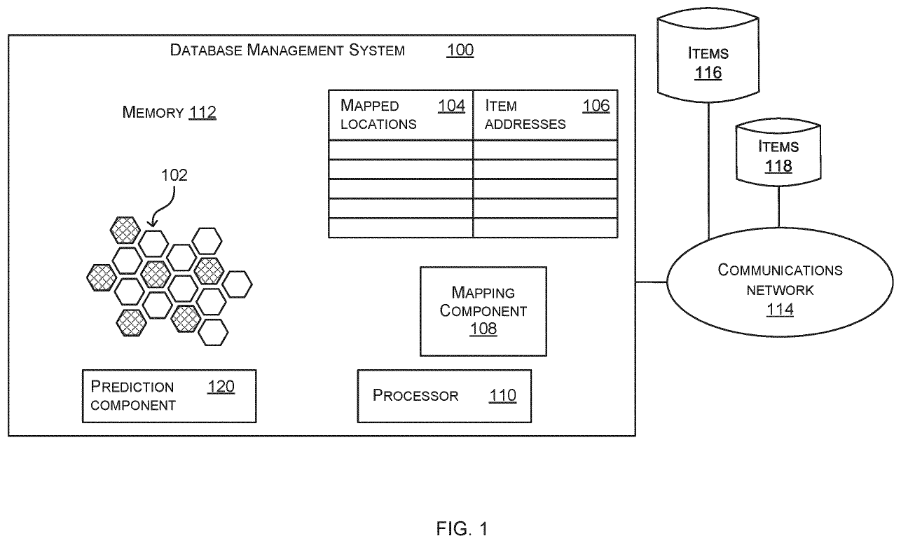

FIG. 1 is a schematic diagram of a database management system 100 connected to a communications network 114 such as the internet, an intranet or any other communications network. Stores 116, 118 of items are accessible to the database management system 100 via communications network 114. The items are measurements such as cyber security event data, traffic data measured from nodes in the communications network 114, or any other data items. Each item has one or more characteristics or features such as a time stamp, category, or other characteristic. In FIG. 1 two stores 116, 118 are shown although in practice the items may be distributed over many different nodes in the communications network 114.

The database management system 100 has a memory 112 which stores addresses 106 of the items together with mapped locations 104 of the items. For each item there is an associated location in a plane or volume comprising a plurality of tessellated cells 102. The locations are computed by a mapping component 108 and so are referred to as mapped locations. The locations are such that, at least to some extent, semantically similar items have similar locations in the plane or volume. In FIG. 1 the plane or volume is not illustrated although the tessellated cells 102 are visible. The database management system also has a processor 110 as explained in more detail later in this document.

The plane or volume together with the tessellated cells and locations 104 associated with item addresses of the disclosure operate in an unconventional manner to achieve a new type of database technology.

The stored item addresses, together with the mapped locations in the plane or volume of tessellated cells improves the functioning of the underlying database by enabling efficient navigation of items in the database.

The database management system of FIG. 1 has low memory and processing costs for storing items in the database and for retrieving items from the database. It is also scalable since it is possible to increase the capacity by increasing the size of the plane or volume, increasing the density of the cells or in other ways such as using a plurality of layers of cells as explained below. The architecture enables different knowledge domains to be integrated within the same database management system since different regions of the plane or volume may be used for different knowledge domains. Where cell coordinates are used, these are easier for human interpretation, than long vectors of floats. A visualisable output is an inherent feature of the resulting tessellated knowledge graph (TKG), where the plane or volume with the cells is a tessellated knowledge graph.

Consider a vector representation of the text label ‘King’. Using vector representation technologies a vector representation of the text label “King” requires up to 300 floating point values. In contrast the present technology is able to provide coordinates for such a label using only 3 float values as described below. The memory and computing costs are therefore reduced by nearly 100 times.

A useful model to compare the process, is to consider how to locate a physical location on a 2D map of the earth. The city of London could be located by giving the distance to London from 300 other cities on the planet. Effectively triangulating the location with respect to the other cities. (Similar, in effect to current vector distance embedding methods).

Alternatively, once a global abstract coordinate system is defined, it is possible to specify the location of London as: 51.5 deg N, 0.127 deg W. Hence, only requiring two float values, plus a meta direction tag.

The inventors have recognized a problem of how to generate, a coordinate system for data in order to enable efficient navigation of the data in a store. The present technology provides a means to auto generate such a coordinate system across any set of data or knowledge; in effect creating a tessellated knowledge graph. In some examples, a tessellated knowledge graph contains a dynamic number of tessellated cells, and these provide a relative coordinate system. The cells have any geometric form such as rectangular, circular, oval, triangular or hexagonal. An hexagonal cell shape is used in the example of FIG. 1, as it provides a highest efficiency in distance calculation, based on studies from biological grid cells.

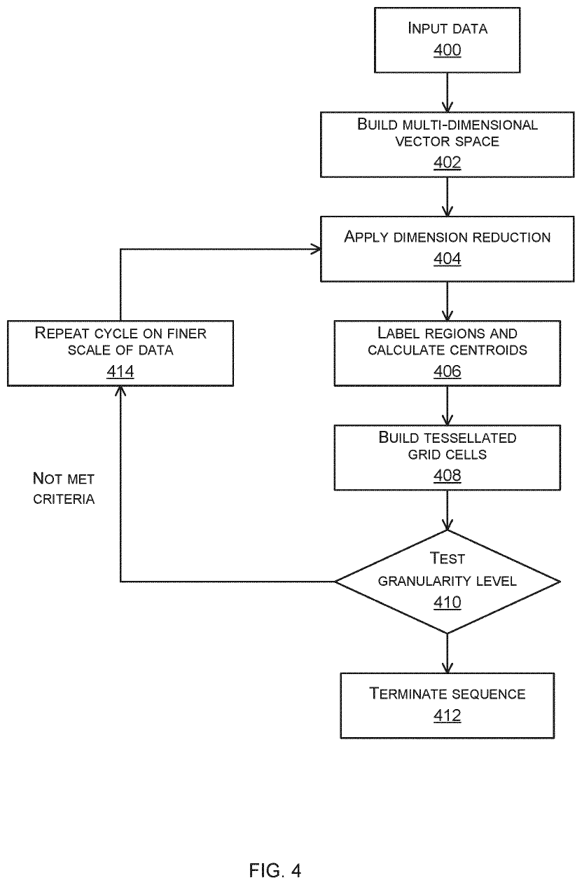

The database management system is computer implemented and comprises one or more processors 110 which are microprocessors, controllers or any other suitable type of processors for processing computer executable instructions to control the operation of the database management system in order to store and retrieve data. In some examples, for example where a system on a chip architecture is used, the processors 110 include one or more fixed function blocks (also referred to as accelerators) which implement a part of the method of any of FIGS. 4, 5B, 6 in hardware (rather than software or firmware). Platform software comprising an operating system or any other suitable platform software is provided at the database management system to enable application software to be executed on the device.

The computer executable instructions are provided using any computer-readable media that is accessible by the database management system 100. Computer-readable media includes, for example, computer storage media such as memory 112 and communications media. Computer storage media, such as memory 112, includes volatile and non-volatile, removable and non-removable media implemented in any method or technology for storage of information such as computer readable instructions, data structures, program modules or the like. Computer storage media includes, but is not limited to, random access memory (RAM), read only memory (ROM), erasable programmable read only memory (EPROM), electronic erasable programmable read only memory (EEPROM), flash memory or other memory technology, compact disc read only memory (CD-ROM), digital versatile disks (DVD) or other optical storage, magnetic cassettes, magnetic tape, magnetic disk storage or other magnetic storage devices, or any other non-transmission medium that is used to store information for access by a computing device. In contrast, communication media embody computer readable instructions, data structures, program modules, or the like in a modulated data signal, such as a carrier wave, or other transport mechanism. As defined herein, computer storage media does not include communication media. Therefore, a computer storage medium should not be interpreted to be a propagating signal per se. Although the computer storage media (memory 112) is shown within the database management system 100 it will be appreciated that the storage is, in some examples, distributed or located remotely and accessed via a network or other communication link.

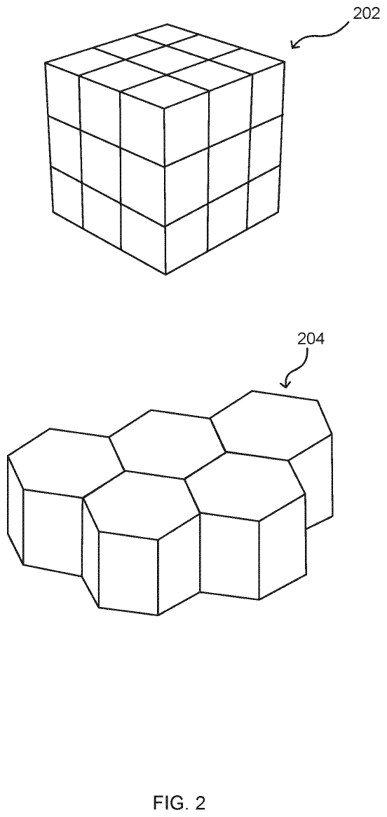

FIG. 2 is a schematic diagram of examples of cells tessellated in a volume for use with the database management system of FIG. 1. In the example of FIG. 1 the cells are planar. However, it is also possible to use 3D cells such as a cuboid 202 formed of smaller cubes, or a honeycomb of 3D hexagons 204 as illustrated in FIG. 2. Any 3D form of cell may be used and a non-exhaustive list of examples is sphere, cube, cuboid, pyramid, cylinder.

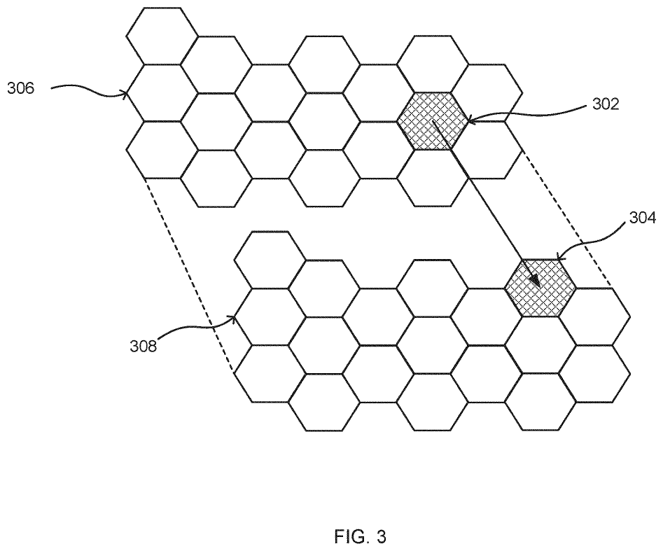

FIG. 3 shows two layers of cells for use with the database management system of FIG. 1. FIG. 3 shows an example with a first layer 306 of planar hexagons and a second layer 308 of planar hexagons superimposed over the first layer 306. Each layer is used to map locations of items for a particular knowledge domain. In an example, each layer of tessellated cells encodes a different type of characteristic of the items. Where an item has a plurality of characteristic types it has a plurality of locations (one per characteristic type layer) and these plurality of locations are concatenated in some examples. In an example, a first layer 306 of tessellated cells encodes cyber security threat intelligence data and a second layer 308 of tessellated cells encodes advance persistent threat data. A new data item that comprises both cyber security threat intelligence data and advance persistent threat data is mapped to a location 302 in the first layer and to a second location 304 in the second layer. In this way the new data item is accurately stored in terms of locations in the database. In the example of FIG. 3 the layers are planar. However it is also possible to have layers which are volumes.

FIG. 4 is a flow diagram of a method of constructing a grid of cells for use with the database management system of FIG. 1. As mentioned above, to create the plane or volume for a particular corpus of items is not straightforward. Input data is received 400 comprising a plurality of items. In an example the items are cyber security event data from a telecommunications network. However, it is not essential for the items to be cyber security event data. Other types of items are used in other examples.

A multi-dimensional vector space is built 402 using any vector embedding method. A vector embedding method is an algebraic method for representing items as vectors of identifiers. A non-exhaustive list of examples of vector embedding methods is: term frequency-inverse document frequency weights, Word2vec, or Glove Vector method. Once the multi-dimensional vector space is built, each item has an embedding vector denoting a position of the item in the multi-dimensional vector space. The multi-dimensional vector space may have hundreds of dimensions in some examples.

A dimension reduction process 404 is then applied to the multi-dimensional vector space to create a 2D map (in the case that a plane is used) or a 3D volume (in the case that a volume is used). A dimension reduction process is a transformation which transforms data from a high-dimensional space into a low dimensional space so that the low dimensional space preserves some meaningful properties of the original data. Any suitable dimension reduction process is used. A non-exhaustive list of examples of dimension reduction process is: neural network autoencoder, generalized discriminant analysis, feature selection, feature projection, T-distributed Stochastic Neighbor Embedding (t-SNE), Uniform Manifold Approximation and Projection (UMAP), principal components analysis {PCA). Although the dimension reduction process reduces redundancy from the multi-dimensional space representation, it preserves at least to some extent, a relationship between distance in the plane or volume and semantic similarity of items.

Within the 2D or 3D map output from operation 404 there are various regions or clusters of the items. These are optionally labelled and optionally centroids of the regions or clusters are calculated 406.

A grid of tessellated cells is then built 408 and placed into the 2D or 3D map. A cell shape is selected, automatically such as by selecting it at random from a list of possibilities, by using a default cell shape, or by receiving user input specifying a cell shape. A cell size is selected in any of the ways as for the cell shape. Using the cell shape and size a tessellating grid is formed to generally cover a majority of the items in the 2D or 3D map. Optionally the grid is positioned so as to put as many of the centroids from operation 406 into cell centers as possible.

A granularity level of the grid is tested 410. The test comprises counting how many items are in each cell. If the average number of items per cell is above a threshold the process moves to operation 414 whereby the cycle (operations 404 to 410) is repeated on a finer scale.

If the average number of items per cell is below the threshold the sequence terminates 412 and the grid of cells is stored. The threshold is set manually or determined through trial and error. Each cell is assigned a unique identifier in some examples.

The method of FIG. 4 is modified in some examples so that the density of cells varies between different regions of the grid. The granularity level test is applied for individual ones of the cells and those cells sub-divided accordingly. A dynamic number of grid cells are placed within each region of the plane or volume, in proportion to the local density of item locations. Hence a sparse region with few items has few grid cells, and denser regions have a higher number of grid cells.

The method of FIG. 4 is modified in some examples so that the grid of tessellating cells is positioned carefully so that centroids of clusters of the item locations tend to fall in the centers of cells.

Operation 404 of FIG. 4 is modified in some examples to use a bias function within the dimension reduction process. The bias function steers the dimension reduction output so that the item locations are more evenly spread within the grid of cells. The advantage of adding the bias is to maximize the fit of the reduced data to match the topology of the grid of cells. Traditional dimension reduction algorithms only seek to optimize the separation of classes within the original high dimension data, rather than steer the output into a specific topology or geometry as in the present technology.

Dimension reduction processes such as t-SNE, are known to be extremely sensitive to parameter selection, which is generally thought to hinder their applicability. The inventors have recognized that since t-SNE can produce a wide range of distinct manifold topologies, from small shifts in the parameter set, it can be steered to generate the required cellular topology output.

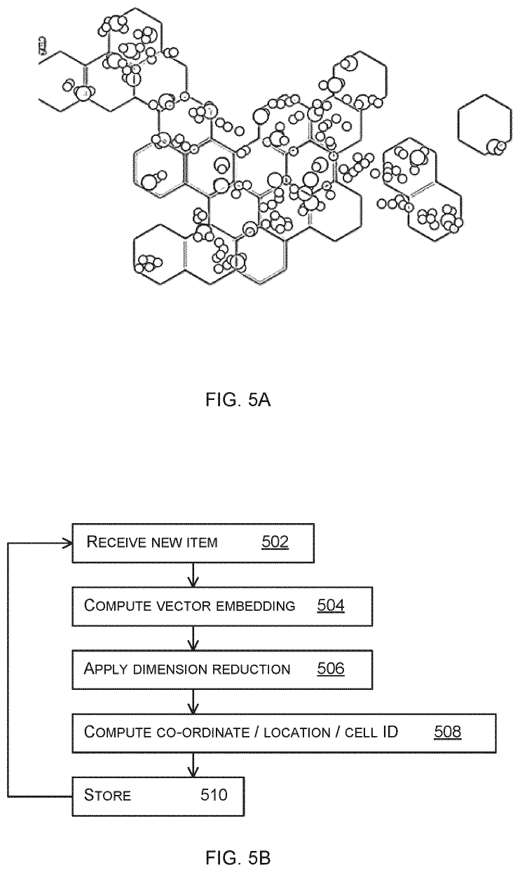

FIG. 5A is an example of a plane comprising tessellated cells and items mapped to the plane. In this example a plurality of cyber security news data items were used to build a multi-dimensional vector space as in operation 402 of FIG. 4. A dimensionality reduction process was applied (t-SNE) to produce a 2D plane with the items located in the plane represented by small circles. An affinity propagation clustering method was applied to cluster the items. The centers of the clusters are represented by large circles in FIG. 5A. A grid of cells was built over the items in the plane as illustrated. It is seen that there are some gaps in the grid of cells; that is there is one “loner” cell and a pair of cells which are not connected to the other cells. In some examples, each cell is assigned a unique identifier code.

FIG. 5B is a flow diagram of a method of mapping new items to a plane or volume for use with the database management system of FIG. 1. A new item is received 502 to be stored in the database. A vector embedding of the item is computed 504 such as by inputting the item to a neural network autoencoder which was used to form the vector embeddings at operation 402 of FIG. 4 or by using any vector embedding process which was used at operation 402 of FIG. 4. The vector embedding is dimensionally reduced at operation 506 to yield a location in the plane or volume (according to whether a plane or volume is being used in the database). In this way a coordinate, location or cell identifier is computed 508 for the item. The coordinate, location or cell identifier is stored 510 in the database in association with an address of the item as explained above with reference to FIG. 1. Thus new items are stored in the database.

It is also possible to add items to the database by filling cells into gaps in the grid. In the example of FIG. 5A cells may be added into gaps between other cells or grown onto the edge of the grid. The existence of items in those cells is then inferred or predicted. The inferred or predicted items are assumed to have similar characteristics to items in the same cell or immediate neighbor cells in the grid.

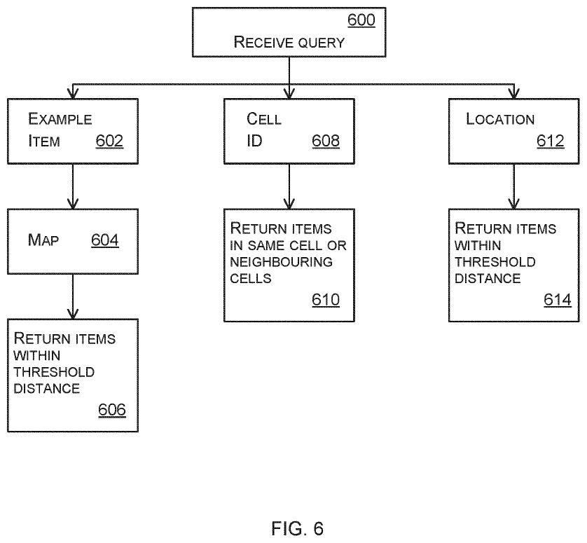

FIG. 6 is flow diagram of a method of processing a query at the database management system of FIG. 1. A query is received 600 from an end user via a user interface, or from an automated process via an application programming interface or other automated interface. In some cases the query is an example item 602 and it is desired for the database management system to return similar items from the database. The example item is mapped 604 to a location, cell or coordinate in the plane or volume using the mapping component 108 of FIG. 1. A search is computed to find items which are within a threshold distance 606 of the example item. Addresses of the items which are found are returned, in some cases, in the form of a ranked list where the addresses of items closest in distance to the example item are ranked highest. This gives an extremely efficient search by example mechanism which is scalable.

In another example the query comprises a cell identifier 608. In this case the database management system searches for items which are in the same cell or neighboring cells of the plane or volume and returns addresses of those items. Where cell identifiers are used the search for items is particularly efficient since the identifiers facilitate simple comparisons. In some cases the cell identifiers are numerically ordered so as the facilitate the search efficiency further.

In another example the query comprises a location 612 or coordinate. In this case the database management system searches for items which are within a specified distance of the location or coordinate in the query. Where coordinates are used the search is very efficient since subtraction is used to compute the distances.

In some examples, the present technology is deployed in robotic and drone systems where real-time mapping is required. A major advantage, in these deployments, is that the present technology provides a means to integrate spatial navigation and knowledge navigation in a single algorithmic process.

The methods described herein are performed, in some examples, by software in machine readable form on a tangible storage medium e.g. in the form of a computer program comprising computer program code means adapted to perform all the operations of one or more of the methods described herein when the program is run on a computer and where the computer program may be embodied on a computer readable medium. The software is suitable for execution on a parallel processor or a serial processor such that the method operations may be carried out in any suitable order, or simultaneously.

Those skilled in the art will realize that storage devices utilized to store program instructions are optionally distributed across a network. For example, a remote computer is able to store an example of the process described as software. A local or terminal computer is able to access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a digital signal processor (DSP), programmable logic array, or the like.

Any range or device value given herein may be extended or altered without losing the effect sought, as will be apparent to the skilled person.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The operations of the methods described herein may be carried out in any suitable order, or simultaneously where appropriate. Additionally, individual blocks may be deleted from any of the methods without departing from the scope of the subject matter described herein. Aspects of any of the examples described above may be combined with aspects of any of the other examples described to form further examples without losing the effect sought.

The term ‘comprising’ is used herein to mean including the method blocks or elements identified, but that such blocks or elements do not comprise an exclusive list and a method or apparatus may contain additional blocks or elements.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the scope of this specification.

1. A database management system comprising:
a memory storing a plurality of addresses of items;
a mapping component for computing a mapped location of each item in a plane or volume comprising a plurality of tessellated cells;
the memory storing, for individual ones of the items, the mapped location of the item.

2. The database management system of claim 1 wherein the location in the plane or volume is one or more of: a Cartesian coordinate, an identifier of one of the tessellated cells.

3. The database management system of claim 1 wherein the mapping component is configured to build a multi-dimensional vector space encoding semantic distance between the items and to compute, for an individual one of the items, a vector embedding of the item in the multi-dimensional space, and to apply a dimension reduction process to the vector embedding to output a location in the plane or volume comprising the plurality of tessellated cells.

4. The database management system of claim 1 wherein the mapping component is configured to: build a multi-dimensional vector space encoding semantic distance between the items; compute the plane or volume by computing a dimension reduced version of the vector space; construct the tessellated cells over the dimension reduced version of the vector space.

5. The database management system of claim 5 wherein the mapping component is configured to assign cluster labels to regions of the dimension reduced version of the vector space.

6. The database management system of claim 4 where the dimension reduced process comprises a bias function to maximize a fit of the dimension reduced version of the vector space to a plane or volume comprising the tessellated cells.

7. The database management system of claim 1 comprising a processor configured to receive a query comprising an example item; use the mapping component to map the query to a location in the plane or volume, and to return items from the memory which are within a specified distance of the query location.

8. The database management system of claim 1 wherein the plurality of tessellated cells comprises a plurality of layers of tessellated cells.

9. The database management system of claim 8 wherein each layer of tessellated cells encodes a different type of characteristic of the items.

10. The database management system of claim 8 wherein the mapping component is configured to map at least one of the items to a first location in a first layer of the tessellated cells and also to a second location in a second layer of the tessellated cells.

11. The database management system of claim 1 wherein the plurality of tessellated cells comprises a first group representing a first knowledge domain and a second group representing a second knowledge domain different from the first knowledge domain, and wherein the first group joins the second group.

12. The database management system of claim 1 wherein at least one of the cells has been divided using sub-cell scaling whereby a recursive cell division process is applied to the cell and to new cells divided from the cell.

13. The database management system of claim 1 comprising a prediction component, which predicts items by adding cells to edges of the tessellated cells or to gaps between the tessellated cells.

14. The database management system of claim 1 wherein the memory stores instructions which when executed on a processor act to:
receive a query comprising a cell identifier of one of the tessellated cells, and
retrieve from memory, locations of other items which have locations in the same cell or a neighboring cell; OR
receive a query comprising a location and retrieve from memory, locations of other items which are within a threshold distance of the received location.

15. A computer-implemented method comprising:
storing, at a memory, a plurality of addresses of items;
mapping each item to a location in a plane or volume comprising a plurality of tessellated cells;
for individual ones of the items, storing the location of the item in the plane or volume.
